(19) United States
(12) Patent Application Publication
(10) Pub. No.: US 2014/0240225 A1
(43) Pub. Date: Aug. 28, 2014

(54) METHOD FOR TOUCHLESS CONTROL OF A DEVICE

(71) Applicant: POINTGRAB LTD., Hod Hasharon (IL)

(72) Inventor: Eran Eilat, Givatayim (IL)

(73) Assignee: POINTGRAB LTD., Hod Hasharon (IL)

(21) Appl. No.: 14/190,148

(22) Filed: Feb. 26, 2014

Related U.S. Application Data
(60) Provisional application No. 61/769,287, filed on Feb. 26, 2013.
(60) Provisional application No. 61/826,293, filed on May 22, 2013.

(51) Int. Cl. G06F 3/01

(52) U.S. Cl. CPC G06F 3/017
USPC 345/156

(57) ABSTRACT

The invention relates to a system and method for computer vision based control of a device which includes, in one embodiment, obtaining a series of images of a field of view, the field of view including a user's hand; identifying a shape of the user's hand in an image from the series of images; identifying a location within the image of the user's hand in a pre-defined shape; and controlling the device based on an overlap of the location of the hand in the pre-defined and a location of an object in the image.

### CROSS REFERENCE TO RELATED APPLICATION

This application claims the benefit of U.S. Provisional Application No. 61/769,287, filed on Feb. 26, 2013, and of U.S. Provisional Application No. 61/826,293, filed on May 22, 2013, both of which are incorporated by reference in their entireties.

### FIELD OF THE INVENTION

The present invention relates to the field of machine-user interaction. Specifically, the invention relates to user control of electronic devices that can display content and user interaction with augmented reality scenes.

### BACKGROUND OF THE INVENTION

The need for more convenient, intuitive and portable input devices increases, as computers and other electronic devices become more prevalent in our everyday life.

Recently, human gesturing, such as hand gesturing, has been suggested as a user interface input tool in which a hand gesture is detected by a camera and is translated into a specific command Gesture recognition enables humans to interface with machines naturally without any mechanical appliances. Additionally, gesture recognition enables operating devices from a distance; the user need not touch a keyboard or a touchscreen in order to control the device.

Typically, when operating a device having a display, once a user's hand is identified, an icon appears on the display to symbolize the user's hand and movement of the user's hand is translated to movement of the icon on the device. The user may move his hand to bring the icon to a desired location on the display to interact with the display at that location (e.g., to emulate mouse right or left click by hand posturing or gesturing).

In an augmented reality system, a user's view of the real world is enhanced with virtual computer-generated graphics. These graphics are spatially registered so that they appear aligned with the real world from the perspective of the viewing user. For example, the spatial registration can make a virtual object appear to be located on a real surface such as a real world patch of grass or tree.

Augmented reality processing of video sequences may be performed in order to also provide real-time information about one or more objects that appear in the video sequences. With augmented reality processing, objects that appear in video sequences may be identified so that supplemental information (e.g., augmented information) can be displayed to a user about the objects in the video sequences. The supplemental information may include graphical or textual information overlayed on the frames of the video sequence so that objects are identified, defined, or otherwise described to a user by augmented information.

Augmented reality systems have previously been implemented using head-mounted displays that are worn by the users. A video camera captures images of the real world in the direction of the user's gaze, and augments the images with virtual graphics before displaying the augmented images on the head-mounted display.

US publication number 2012/0154619 describes an augmented reality system which includes a video device having two different cameras; one to capture images of the world outside the user and one to capture images of the user's eyes. The images of the eyes provide information about areas of interest to the user with respect to the images captured by the first camera and a probability map may be generated based on the images of the user's eyes to prioritize objects from the first camera regarding display of augmented reality information.

Alternative augmented reality display techniques exploit large spatially aligned optical elements, such as transparent screens, holograms, or video-projectors to combine the virtual graphics with the real world. Virtual reality glasses (e.g., glasses worn on a person's face similar to reading glasses) exist which include a see through display and a virtual reality engine to cause the see-through display to visually present a virtual display or monitor that appears to be integrated with the real world viewed by the user through the see through display. Some virtual reality glasses include a camera and processor to follow the user's eyes or to capture the user's hand gestures to enable control of the virtual reality engine. In this case a user may use hand gestures on the real-world scene which he sees through the see-through display and his hand gestures are identified by their movement and 3 dimensional position.

Interaction with a touch screen may also be used to interact with displayed reality. For example, a user may touch a touch sensitive screen of a cell phone or other mobile device which is displaying images obtained by a camera of the mobile device, to cause graphics to appear on the display at the location of the interaction with the touch sensitive screen.

Augmented reality has uses in many fields. For example, catalogers and ecommerce providers sometimes use quick response codes (QR codes) to deliver content and support virtual shopping experiences. QR codes are a type of matrix barcode (or two-dimensional bar code) that can be read by an imaging device and may be formatted algorithmically by underlying software. Data is then extracted from patterns present in both horizontal and vertical components of the image. QR codes attached to real world elements can cause augmented information (typically relating to the real world element to which the QR code is attached) to be displayed to a user viewing the real world elements through an imaging device display.

Current augmented reality devices and applications require specific and often expensive aids, such as touch screens, QR codes, virtual reality glasses etc., to enable user interaction with real world images.

### SUMMARY

Methods for machine-user interaction, according to embodiments of the invention, enable easy and intuitive user interaction with a real world image and/or with an augmented image.

According to one embodiment of the invention there is provided a method for computer vision based control of a device which includes the steps of obtaining a series of images of a field of view, the field of view including a user's hand; identifying the user's hand in an image from the series of images; identifying a location within the image of the user's hand; and controlling the device based on an overlap of the location of the hand and a location of an object in the image.

According to some embodiments of the invention a real world image which does not include a user, is obtained (e.g., by a camera that is facing away from the user). The user may then introduce his hand in the field of view of the camera such that the real world image includes real world elements and the user's hand. The user's hand is detected in the image and a pre-defined posture of the user's hand is identified. A device can then be controlled based on the location of the hand in the pre-defined posture, in the image.

The device controlled according to embodiments of the invention may include the camera used to obtain the real world image or another device which is associated or in communication with the camera.

Controlling the device may include causing an interaction with the image (e.g., with a real world element in the image and/or with a synthetic element added to the real world image) such as causing a graphical element to appear on a displayed image, moving parts of the image, zooming in/out, etc.

### BRIEF DESCRIPTION OF THE FIGURES

The invention will now be described in relation to certain examples and embodiments with reference to the following illustrative figures so that it may be more fully understood. In the drawings:

FIG. 1 schematically illustrates a user-device interaction system according to an embodiment of the invention;

FIGS. 2A-E schematically illustrate methods for controlling a device according to embodiments of the invention; and

FIGS. 3A-B schematically illustrate methods for controlling a device based on movement of the user's hand, according to embodiments of the invention.

### DETAILED DESCRIPTION OF THE INVENTION

Embodiments of the present invention provide methods for controlling a device by user interaction with a real world scene. Methods according to embodiments of the invention translate the location of a user's hand in an image of the real world to enable simple interaction with the image and with real world elements in the image.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” “identifying”, “determining” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

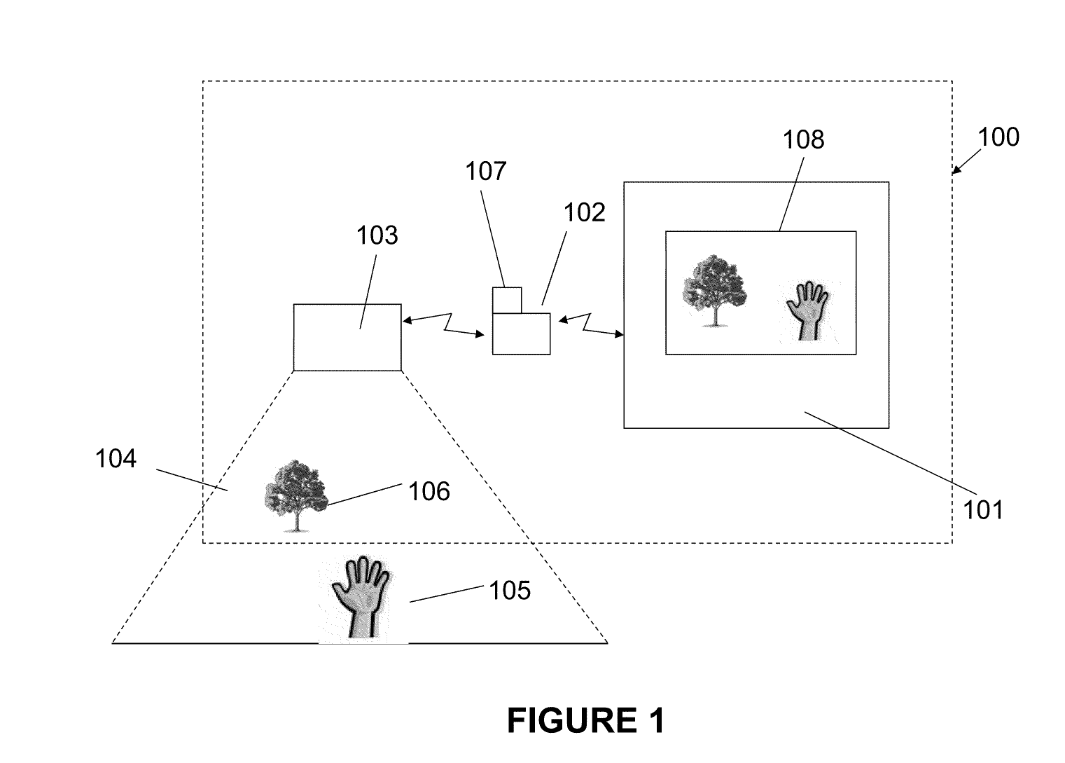

Methods according to embodiments of the invention may be implemented in a user-device interaction system, which is schematically illustrated in FIG. 1, however, other systems may carry out embodiments of the present invention. Methods according to embodiments of the invention are typically carried out by using a processor, for example, as described below.

The system 100 includes a device 101 to be operated and controlled by touchless user commands, and an image sensor 103. The device 101 may include or may be associated with or in communication with a display 108 (e.g., an LCD monitor, an O-LED monitor, glassware for virtual reality devices, etc.). According to embodiments of the invention user commands are generated based on identification of a user's hand 105. The system 100 identifies the user's hand 105 in the images obtained by the image sensor 103. Once a user's hand 105 is identified it may be tracked such that movement of the hand may be followed and translated into input, operating and control commands. According to one embodiment, a pre-defined posture of the hand is identified and the user command may be generated based on the identified posture of the hand.

A system 100 operable according to embodiments of the invention typically includes an image sensor 103 to obtain image data of a field of view (FOV) 104. The image sensor 103 may be a 2D or 3D camera or other appropriate imager. The FOV may include real world elements, such as a tree 106, and may include a user's hand 105 (e.g., a forward facing camera may capture a FOV that includes the user and the world in the background of the user. Alternatively, a camera may be facing away from the user to capture the world outside of the user and the user may then place his hand within the FOV).

The image sensor 103, which may be a standard two dimensional (2D) camera, may be associated with a controller or processor 102 and a storage device (e.g., a memory) 107 for storing image data. The storage device 107 may be integrated within the image sensor 103 or may be external to the image sensor. According to some embodiments, image data may be stored in the processor 102, for example in a cache memory. In some embodiments image data of a field of view (which includes a user's hand) is sent to the processor 102 for analysis. A user command or input may be generated by the processor 102, based on the image analysis, and may be sent to the device 101, which may be any electronic device that can accept user commands, e.g., television (TV), DVD player, personal computer (PC), mobile phone, camera, STB (Set Top Box), streamer or a device having virtual reality capabilities such as virtual/augmented reality glasses (e.g., Google Glass™) etc. According to some embodiments more than one processor may be used by the system. Controller or processor 102 may be configured to carry out methods according to embodiments of the invention by, for example, being connected to a memory such as storage 107 containing software or code which when executed cause the controller or processor to carry out such methods.

According to one embodiment the device 101 is an electronic device available with an integrated standard 2D camera. According to other embodiments the camera is an external accessory to the device. An external camera may include a processor and appropriate algorithms for gesture/posture recognition. According to some embodiments, more than one 2D camera is provided, for example, to enable obtaining 3D information. According to some embodiments the system includes one or more 3D and/or stereo camera. According to some embodiments, the image sensor 103 can be IR sensitive.

One or more detectors may be used for correct identification of a real world object and for identification of a user's hand and different postures of the hand. For example, a contour detector may be used together with a feature detector.

Methods for tracking a user's hand may include using an optical flow algorithm or other known tracking methods.

Communication between the image sensor 103 and the processor 102 and/or between the processor and the device may be through a wired or wireless link, such as through IR communication, radio transmission, Bluetooth technology and other suitable communication routes and protocols.

According to one embodiment detecting a user's hand is done by using shape detection. Detecting a shape of a hand, for example, may be done by applying a shape recognition algorithm (for example, an algorithm which calculates Haar-like features in a Viola-Jones object detection framework), using machine learning techniques and other suitable shape detection methods, and optionally checking additional parameters, such as color parameters.

Detecting part of a hand, such as a finger may be done, for example, by segmenting and separately identifying the area of the base of a hand (hand without fingers) and the area of the fingers, e.g. the area of each finger. Separately identifying the hand area and the finger areas provides means for selectively defining tracking points that are either associated with hand motion, finger motion and/or a desired combination of hand and one or more finger motions. According to one embodiment four local minimum points in a direction generally perpendicular to a longitudinal axis of the hand are sought. The local minimum points typically correspond to connecting areas between the fingers, e.g. the base of the fingers. The local minimum points may define a segment and a tracking point of a finger may be selected as a point most distal from the segment.

According to one embodiment movement of a hand or finger along the Z axis relative to the camera (towards or away from the camera) may be defined as a gesture to generate a certain command such as “select” or other commands. Movement along the Z axis may be detected by detecting a pitch angle of a finger (or other body part or object), by detecting a change of size or shape of the finger or other object, by detecting a transformation of movement of selected points/pixels from within images of a hand, determining changes of scale along X and Y axes from the transformations and determining movement along the Z axis from the scale changes or any other appropriate methods, for example, by using stereoscopy or 3D imagers.

As will be further detailed below and according to some embodiments of the invention, a user's hand may be imaged in a real world scene. For example, a user may use a camera (such as an imager typically provided with cell phones, PCs, tablet computers or augmented reality glasses) to image a scene. The user may then introduce his hand into the scene such that the camera images both the real world scene and the user's hand. The scene obtained by the camera may be displayed to the user such that the user can see an image of the scene and his hand within the scene. The user may then bring his hand to a specific location in the image of the real world scene to interact with the real world scene, for example, to control the camera or other device associated with the camera based on an overlap of the location of his hand and a location of an object in the image.

According to one embodiment a gesture or a specific, pre-defined posture performed by the user (such as bringing together the tips of two opposing fingers to create a closed shape, such as when the fingers are making a “pinching” motion) at a specific location in the real world scene can cause an interaction at that location.

A user may thus interact with reality to provide “augmented reality” without having to touch actual objects in the real world scene, just by directing his hand at a desired location within an imaged scene. In addition, a user may thus interact with any desired object in the scene without having to specially mark objects in advance since a system operative according to embodiments of the invention operates by identifying a user's hand and then identifying the location of the hand within an imaged scene, rather than identifying a specific location or object within an imaged scene (e.g., an object in a real scene having a QR code sticker on it) and then trying to correlate a hand with the location or object.

According to one embodiment the method includes identifying a user's hand by detecting a shape of a hand or of part of a hand (e.g., a finger) and tracking a user's hand or part of the user's hand (e.g., one or more fingers) within the field of view obtained by the camera. Based on the identification of a shape of a hand and, according to some embodiments, on identification of a pre-defined gesture or posture of the hand, an interaction is performed at the location of the posturing or gesturing hand.

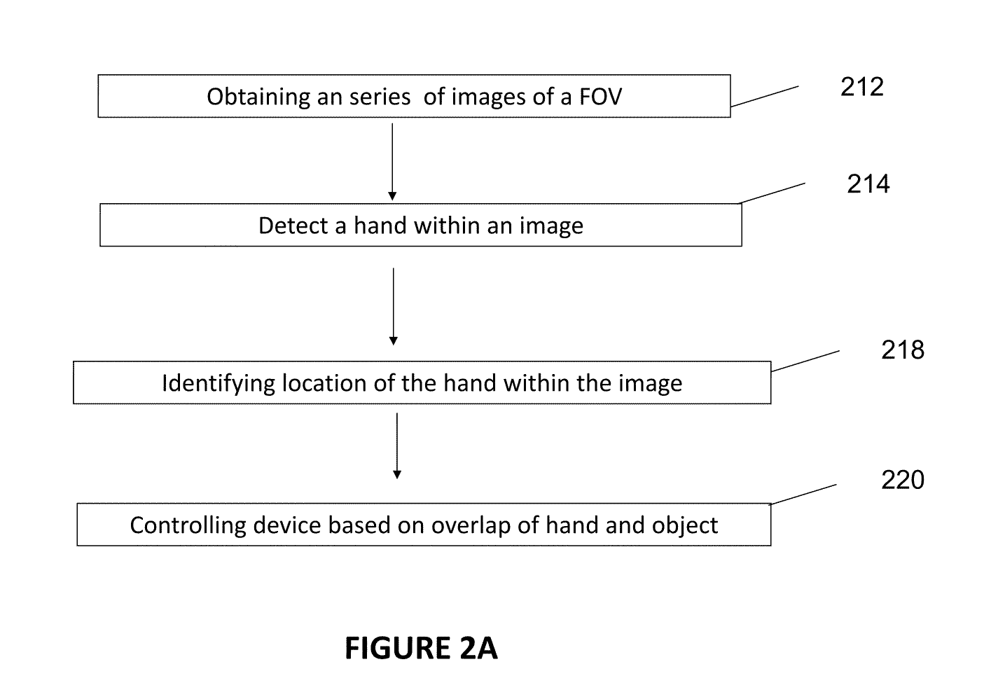

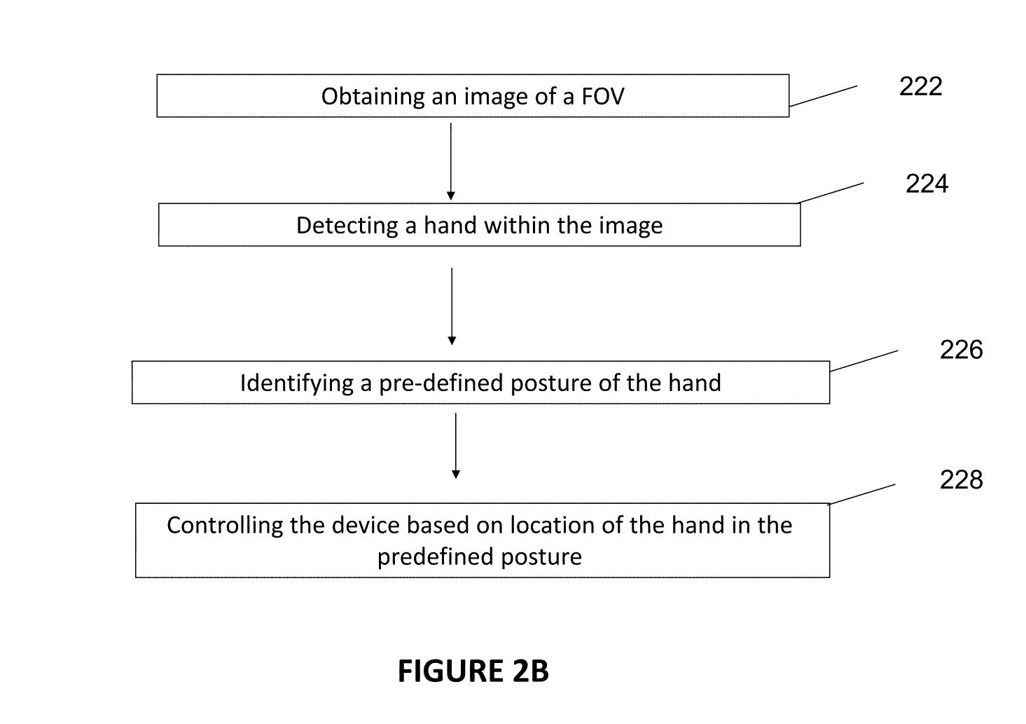

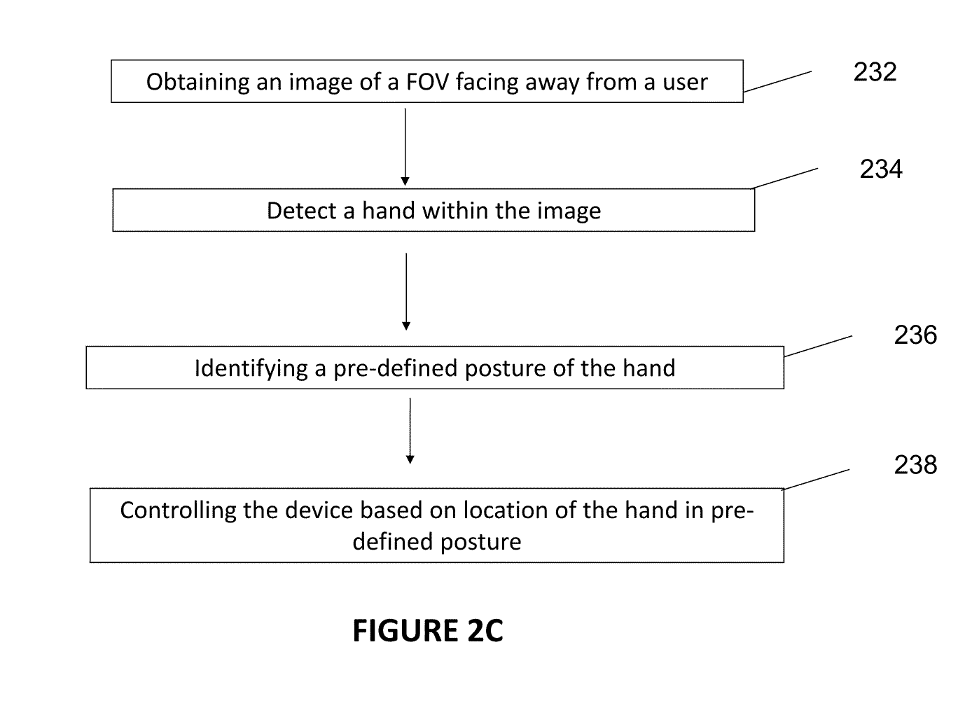

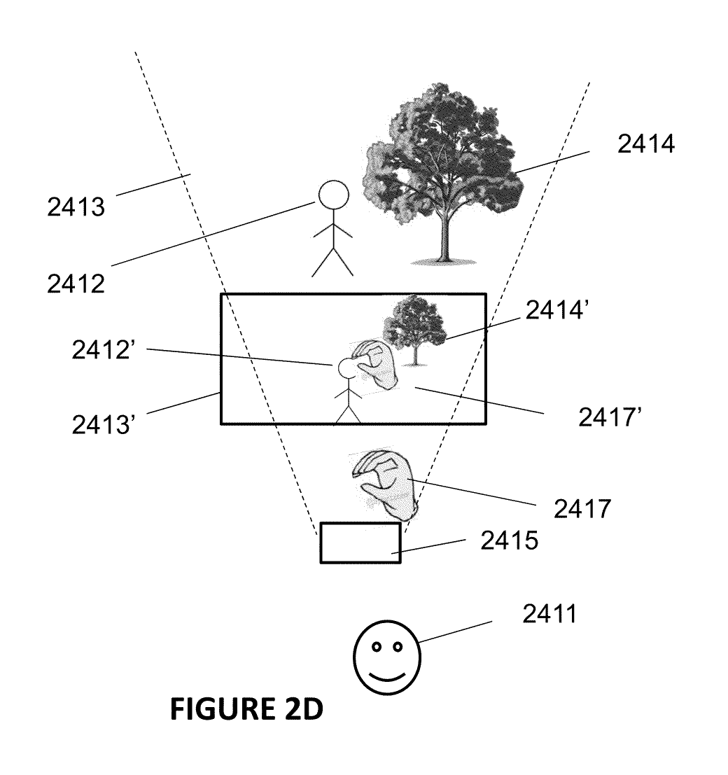

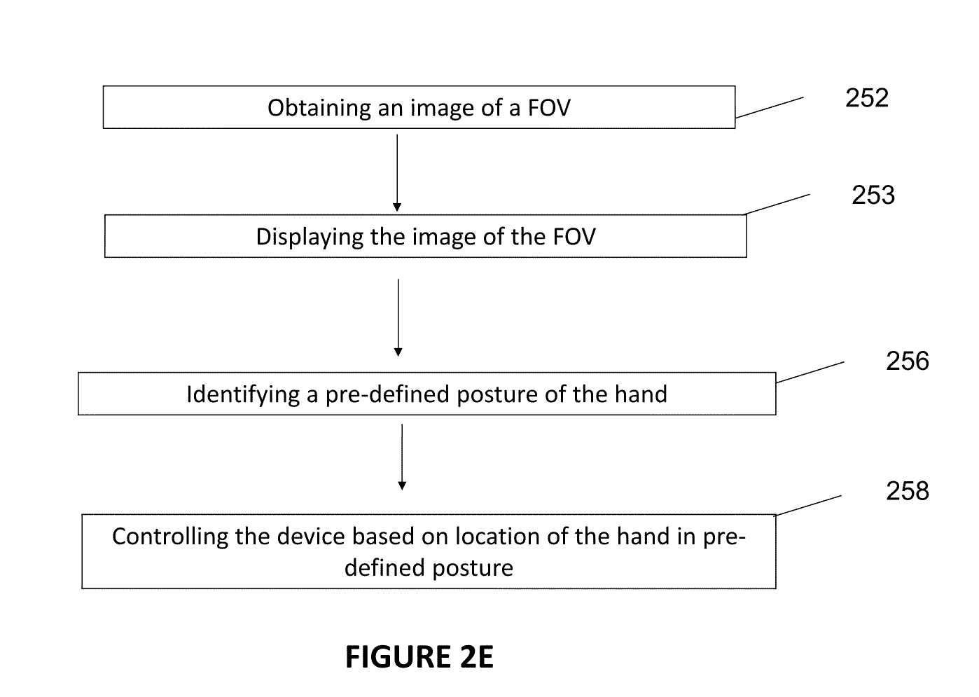

Methods for controlling a device according to embodiments of the invention is schematically illustrated in FIGS. 2A, 2B, 2C, 2D and 2E.

A method according to one embodiment which is schematically illustrated in FIG. 2A, includes obtaining, e.g., from a camera and by using processor 102 or another processor, a series of images of a field of view, the field of view including a user's hand (212) and detecting or identifying a hand within an image from the series of images (214) (e.g., by applying shape recognition algorithms to detect the shape of a hand). Once the hand is identified the location of the hand within the image is identified (218) and a device may be controlled based on an overlap of the location of the hand and the location of an object in the image (220).

For example, if it is determined that a hand location coincides or overlaps a location of an object then a user command may be generated (e.g., to interact with a display of the device). If it is determined that the location of a hand does not overlap the location of an object in the image then no user command is generated.

According to one embodiment the user's hand may be tracked throughout the series of images. In one embodiment, a certain, pre-defined, posture of the hand may be identified, for example, in one or some of the images of the series of images, and the device may be controlled based on an overlap of the location of the hand in the pre-defined posture and the location of an object in the image.

According to some embodiments the step of detecting a hand within the image may be avoided and a pre-defined posture of a hand may be detected without prior detection of a user's hand.

As schematically illustrated in FIG. 2B, the method according to one embodiment, may include obtaining an image of a field of view, the field of view including a real world element and a user's hand (222); detecting a hand within the image (224) (e.g., by applying shape recognition algorithms to detect the shape of a hand); and identifying a certain, pre-defined, posture of the hand (226) (e.g., by detecting a movement having specific characteristics or a movement in a specific pattern, by detecting the shape of the hand or by other suitable methods). Once the pre-defined posture is identified, a device may be controlled (e.g., an interaction with a real world element is caused) (228), based on the location of the hand in the pre-defined posture, in the image.

Thus, according to one embodiment, a method for computer vision based control of a device includes detecting a first shape of a user's hand within a first image from a series of images of a field of view and possibly tracking that first shape. A second shape of the user's hand may then be detected within a second image from the series of images and the location within the second image of the second shape of the user's hand may then be determined to control the device based on an overlap of the location of the second shape of the hand and a location of an object in the second image.

Initially identifying a hand by its shape and then identifying another, pre-defined shape (posture) of the hand enables accurate control of the device.

Determining a location of a hand or any other object in an image and determining their overlap can be done, for example, by defining pixels from within the identified hand shape as “hand pixels” and defining pixels from within boundaries of other imaged objects (recognized, for example, by using known image segmentation algorithms) as “object pixels”. An image analysis algorithm may determine when object pixels are partially or fully covered or changed (typically changed to hand pixels). Overlap may be for example when all or part of one object is located in the same portion of the image or FOV as that of the other object.

A shape of a hand may include, for example, a hand in which the thumb is touching or almost touching another finger so as to create an enclosed space (such as in a “pinching” posture of the fingers). In this case “hand pixels” may include a pixel or group of pixels located at or in the vicinity of the meeting point of the thumb and other finger (e.g., in between the two fingers before the fingers meet). According to some embodiments, when this pixel or group of pixels covers the object pixels, it may be determined that the location of the hand and the location of an object overlap.

Overlap of the location of a hand and the location of an object in the image may be defined, for example, through the percentage of object pixels changed to hand pixels or percentage of covered object pixels. Overlap may be defined, for example, as more than 50% covering or change of object pixels or any other suitable percentage or definition.

In some embodiments overlap may be defined based on a pre-defined point in the hand shape and/or in the object. For example, according to one embodiment, a shape of a hand and a shape of an object in the image may be detected; a center point of the hand shape may be calculated (e.g., a point at essentially equal distance from left and right boundaries of the hand shape) as may be calculated a center point of the object shape. A hand may be considered overlapping the object when the calculated center point of the hand shape is within the boundaries of the object shape or when the two center points of the hand shape and object shape coincide or any other relative locations of the pre-defined points or of one point relative to a shape (e.g., the center point of the object coinciding with the shape of the hand or vice-versa).

Control of a device may be dependent on an overlap of the location of the hand and the location of an object in the image. Control of a device may include interaction with an object in the image. According to some embodiments an “object” may be a real world object (e.g., a tree or person or other object from a real world scene) or a synthetic graphical object which can be added onto the image.

According to some embodiments the real world scene and/or an object from the real world scene are displayed on a display, e.g., a phone or PC or tablet computer display, a virtual reality glasses display, etc. An indication may also be displayed throughout tracking of the user's hand (e.g., an icon or cursor that moves on screen in accordance with movement of the user's hand) and/or when the location of the user's hand overlaps a location of an object in the image (e.g., a symbol appearing on the display or other, not necessarily displayed indication, such as a sound or vibration) in order to give the user feedback regarding operation of the system.

According to another embodiment, which is schematically illustrated in FIG. 2C, the method may include obtaining, for example, by means of a camera facing away from a user, an image of a field of view (232), the field of view including a real world element and the user's hand; detecting the user's hand in the image (234); identifying a pre-defined posture of the user's hand (236); and controlling the device based on the location of the hand in the pre-defined posture in the image (238).

According to one embodiment the detection of the pre-defined posture may generate a user command, for example, a command to select. For example, a user may introduce his hand in the FOV of a camera imaging a real world scene. The user may move his hand (e.g., in a first shape) through the scene but when his hand reaches a desired object or location in the scene, the user may perform a pre-defined posture (e.g., a second shape) with his hand (e.g., a “pinching” posture or pointing a finger) to select or otherwise interact with the object or location within the image.

Thus, a method according to one embodiment of the invention includes detecting a pre-defined shape of a user's hand within a series of images of a field of view and then detecting a change of the pre-defined shape of the user's hand within the series of images. Once a change of the pre-defined shape is detected a location of the hand in an image from the series of images is identified and the device may be controlled based on the overlap of the location of the user's hand and a location of an object in that image.

The change of shape of the user's hand may be detected, for example, by applying a shape recognition algorithm to detect a shape of the user's hand or by detecting a movement in a specific pattern.

Selecting an object, for example, may enable the user to move the selected object on the display according to movement of the user's hand while the hand is in the pre-defined posture.

According to some embodiments when the pre-defined posture is no longer identified the command to select is ended (and selected object is “dropped”). According to some embodiments the method may include a step of identifying another, third, shape of the user's hand and the detection of the third shape ends the command to select.

Controlling the device may include interacting with real world or synthetic elements in a displayed image.

For example, as schematically illustrated in FIG. 2D, an image of a FOV 2413 may be obtained through a camera of a user's 2411 smartphone 2415 (or other device, such as virtual reality glasses). The image of the FOV 2413 includes real world images such as a tree 2414 and a person 2412. The user 2411 may introduce his hand 2417 into the FOV 2413 such that the image 2413′ that is displayed to the user 2411 includes the tree, 2414′, the person 2412′ and the user's hand 2417′.

In one embodiment the user's hand 2417′ (e.g., in a posture where two opposing fingers of a user's hand touching or almost touching at their tips) in the image 2413′ is located at or near a real world element, such as the person 2412′. The user 2411 may then posture such that two fingers of the user's hand 2417 are touching or almost touching at their tips. Identification of such (or other pre-defined) posture will cause an interaction in the image 2413′ at or near the person 2412′ (or at or near the location of the hand in the pre-defined posture in the image).

The interaction may include adding a graphical element to the image, e.g., adding a text box or icon that contextually relates to the person 2412′ or that contextually relates to the location of the user's hand 2417′ within the image 2413′. For example, a text box may include information relating to the tree 2414 (e.g., if the user's hand 2417′ in the image is located at or near the tree 2414′ in the image). In another example, the graphical element may include points or other icons related to a game in which the user 2411 and the person 2412 are participating.

According to one embodiment the method includes detecting at least one finger of the user's 2411 hand 2417.

Thus, according to one embodiment, which is schematically illustrated in FIG. 2E, a method for controlling a device may include obtaining, by means of a camera facing away from a user (e.g., capturing a point of view opposite or 180 degrees from the point of view towards the user) or a camera facing or towards the user, an image of a field of view (252), the field of view including a real world element and the user's hand. The image of the field of view is then displayed, for example, to the user (e.g., on a display connected to the camera) (253). The method may include identifying a pre-defined posture of the user's hand (256) and controlling the device, typically controlling a display of the device (e.g., the display used to display the FOV to the user), based on the location of the hand in the pre-defined posture in the image (258).

The method may include a step of detecting the user's hand in the image prior to identifying a pre-determined posture of the hand.

In embodiments of the invention a user interacts with an image displayed to him (e.g., in step 253) enabling easy and accurate location of the user's hand in relation to objects in that image (real world objects or added graphical objects). Additionally, the step of displaying the image of the FOV to the user and having the user interact with the image rather than having the user interact with the scene directly visible to his eyes, enables using embodiments of the invention in applications not enabled by existing virtual reality devices, such virtual reality glasses. For example, a user may interact with a synthetic element added to an image of real world objects. Additionally, the user may interact with real world objects in a FOV not directly visible to him.

The user's hand or finger may be tracked throughout a series of images. According to some embodiments identifying the pre-defined posture of the hand includes detecting movement of the hand or of a part of the hand. For example, movement of a hand from an open fingered hand to a closed fist hand could be identified (e.g., by characterizing transformation of points to decide if the whole hand is moving or if only fingers of the hand are moving) and used to indicate a fisted hand posture. According to other embodiments shape detection algorithms are applied to detect the shape of the posture of the hand. According to some embodiments both detecting movement in a specific pattern or having specific characteristics and detecting a shape of the hand may be used to identify a pre-defined posture and/or to identify a change of posture of the hand.

In some embodiments the image 2413′ of the real world can be supplemented by adding a synthetic element (e.g., images, icons, buttons or any other graphics. Icons can be, added, for example, as part of an interactive game). According to embodiments of the invention an interaction can be caused with the synthetic element in the image based on the location of the hand (possibly in a pre-defined posture) in the image, as described above. For example, an interaction (such as a change in the shape or visibility of the icon) may be caused at or in the vicinity of the location of the hand (such as in the vicinity of the location of a tip of one of the fingers of the hand in the pre-defined posture).

For example, when a user directs a finger or hand in which the thumb is almost touching another finger so as to create an enclosed space (such as in a “pinching” or pointing posture of the fingers), at a specific location or synthetic element on a display, a point at the tip or near the tip of the finger (or in between the thumb and other finger) is detected and can be located in the image. A command to cause an interaction can then be applied at the detected location in the image.

Causing an interaction at a location of a specific posture of the hand (e.g., at the tip of a pointing finger or where a finger and a thumb of a user meet when performing a “pinch” posture) ensures easier and more accurate “pointing” so that the user may more easily and intuitively interact with a scene.

According to some embodiments an “interaction with a scene” includes changes to a displayed image, local changes to part of the image (e.g., at the location of the hand in the pre-defined posture) or changes to larger parts of the display or the whole display. For example, a part of an image, a whole image or the whole display may be rotated, enlarged or decreased in accordance with the user's hand movements.

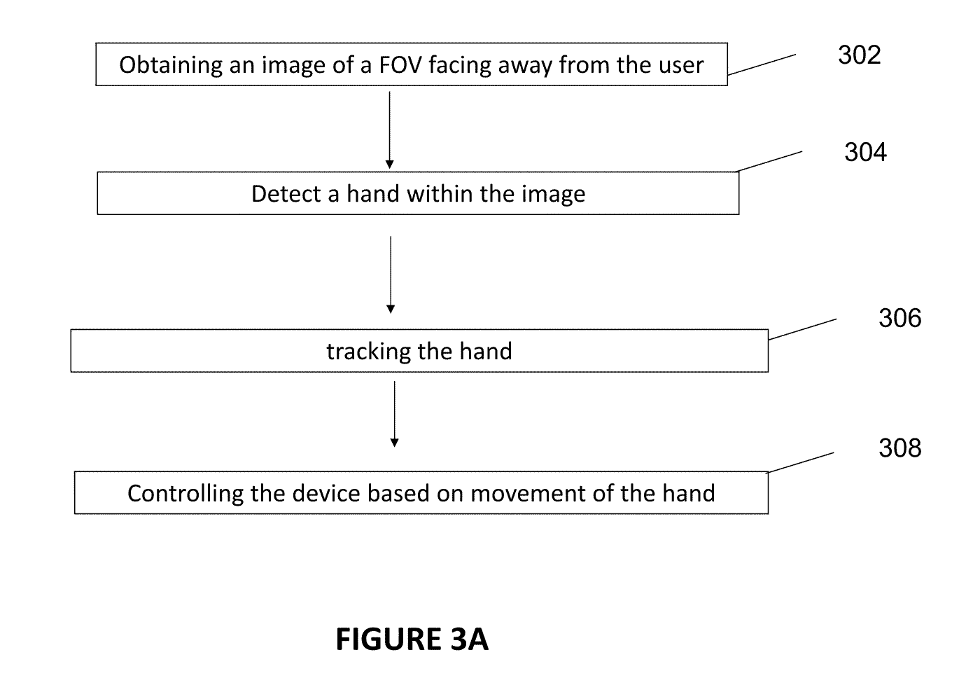

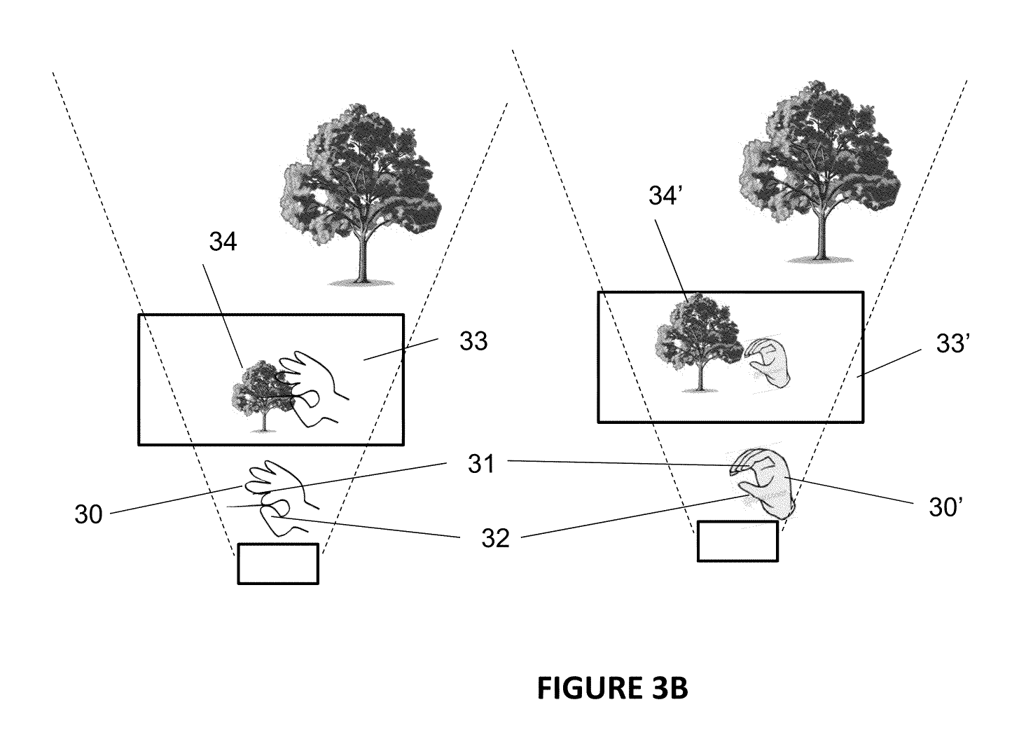

According to one embodiment, which is schematically illustrated in FIG. 3A, a method includes obtaining, e.g., by means of a camera facing away from a user, an image of a field of view (302), the field of view including a real world element and the user's hand; detecting the user's hand in the image (304) and tracking the detected hand in a series of images (306) and controlling a device based on the movement of the tracked hand (308). According to one embodiment the method may include identifying a pre-defined posture of the user's hand and the device is controlled based on the movement of the hand and based on the detection of the pre-defined posture.

According to some embodiments identifying the pre-defined posture of the hand includes detecting movement of the hand or of a part of the hand. For example, the system may determine that a “pinching” posture is being performed based on movement characteristics of opposing fingers of the hand (e.g., as described above).

As described above, controlling the device may include causing an interaction of the device with or at a real world element and/or with or at a synthetic element added to the real world scene.

According to some embodiments the interaction may be dependent on movement of the hand (optionally, the hand in the pre-defined posture) or upon movement of the fingers of the hand. For example, the interaction may include moving at least part of an image or of a display according to the movement of the hand, e.g., left or right, up or down, rotate, etc.

According to one embodiment the interaction may be dependent on movement of the hand (optionally, in a pre-defined posture) towards or away from the camera. As described above, movement of the hand (or finger) on the Z axis relative to the camera may be detected, for example, by detecting changes in size and/or shape of the hand or finger. Thus, the size and/or shape of the hand or finger may also be used by the system to indicate an interaction.

Interactions based on movement of a hand on the Z axis relative to the camera (getting closer or further away from the camera) may include, for example, zooming in or out or changing the graphical user interface, e.g., showing different “image layers” based on the location of the hand on the Z axis, relative to the camera.

According to other embodiments an interaction may be dependent on a distance of two fingers (e.g., two opposing fingers of the same hand) from each other. For example, as schematically illustrated in FIG. 3B, a user's hand posturing in a pinching (or other) posture may be detected by applying shape detection algorithms or by other methods. The distance between the two posturing fingers 31 and 32 may be detected (for example, by detecting the shape of the hand with open fingers, slightly open fingers, slightly closed fingers, etc. or by other methods, such as by tracking the finger tips and calculating their relative position in each frame) and an image 33 or part of an image (such as tree 34) may be stretched (for example, the image of tree 34 may be enlarged in image 33′ to tree 34′), zoomed in or out or otherwise manipulated based on the movement of the fingers 31 and 32 or based on the distance of the fingers from each other. For example, a hand in which two finger tips are almost touching (such as hand 30) may be signal to select a displayed item, such as tree 34, and a hand with the fingers opened (such as hand 30′) may be a signal to stretch the item.

Embodiments of the invention may include an article such as a computer or processor non-transitory computer readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method for computer vision based control of a device, the method comprising
using a processor to
detect a first shape of a user's hand within a first image from a series of images of a field of view;
detect a second shape of the user's hand within a second image from the series of images;
identify a location within the second image of the second shape of the user's hand; and
control the device based on an overlap of the location of the second shape of the hand and a location of an object in the second image.

2. The method of claim 1 comprising using the processor to track the first shape of the user's hand in the series of images.

3. The method of claim 1 wherein the object is a real world object or a synthetic graphical object.

4. The method of claim 1 comprising displaying the field of view on a display.

5. The method of claim 4 comprising displaying an indication on the display when the location of the second shape of the user's hand overlaps the location of the object in the image.

6. The method of claim 1 wherein the detection of the second shape generates a command to select.

7. The method of claim 6 comprising detecting a third shape of the user's hand, wherein the detection of the third shape ends the command to select.

8. The method of claim 1 wherein detecting the second shape of the user's hand comprises applying a shape detection algorithm to detect a shape of the second shape or detecting movement of the hand or of a part of the hand.

9. The method of claim 1 comprising detecting at least one finger of the hand.

10. The method of claim 9 wherein the second shape comprises two opposing fingers of a user's hand, said fingers touching or almost touching at their tips.

11. The method of claim 1 wherein controlling the device comprises causing an event on a display.

12. The method of claim 11 comprising causing an event at or in the vicinity of the location of the second shape of the hand in the image.

13. The method of claim 12 comprising causing an event at or in the vicinity of the location of a tip of one of the fingers of the hand.

14. The method of claim 11 wherein the event is dependent on movement of at least part of the user's hand.

15. The method of claim 14 wherein the event is dependent on movement of the user's hand towards or away from a camera used for obtaining the series of images.

16. The method of claim 11 wherein the event is dependent on a distance of two fingers of the hand from each other.

17. A method for computer vision based control of a device, the method comprising
using a processor to
detect a pre-defined shape of a user's hand within a series of images of a field of view;
detect a change of the pre-defined shape of the user's hand within the series of images;
identify a location within an image from the series of images, of the user's hand, after detecting the change of the pre-defined shape; and
control the device based on an overlap of the location of the user's hand and a location of an object in the image.

18. The method of claim 17 wherein detecting a change of the pre-defined shape of the user's hand comprises applying a shape recognition algorithm to detect a shape of the user's hand or by detecting a movement in a specific pattern.

19. A system for computer vision based control of a device, the system comprising
a processor to
detect a hand of a user within a series of images of a field of view, said field of view obtained from a camera that is facing away from the user;
detect a pre-defined posture of the hand;
identify a location within an image from the series of images, of the pre-defined posture; and
control the device based on an overlap of the location of the pre-defined posture and a location of an object in the image.

20. The system of claim 19 comprising a display in communication with the processor to display the field of view to the user.
